(19) United States
(12) Patent Application Publication
(10) Pub. No.: US 2015/0142697 A1
(43) Pub. Date: May 21, 2015

(54) Stock Slots

(71) Applicants: Gary Dale Sacco, Doral, FL (US); Joseph L. Filbrun, West Chester, OH (US)

(72) Inventors: Gary Dale Sacco, Doral, FL (US); Joseph L. Filbrun, West Chester, OH (US)

(21) Appl. No.: 14/014,436

(22) Filed: Nov. 15, 2013

(51) Int. Cl. G06Q 40/06

(52) U.S. Cl. CPC G06Q 40/06
USPC 705/36 R

(57) ABSTRACT

Stock market performance is used and that data is translated into slot machine results. The application-based slot machine that uses a formula to translate stock performance into slot machine spin results. The application-based slot machine combines the excitement and entertainment value of casino gambling with the importance of saving or investing. Instead of “winnings” or “losses” being a result of gambling, they are a result of investment choices. By making investing/saving fun, the application-based slot machine encourages smart investing rather than true casino gambling.

### BACKGROUND OF THE INVENTION

1. Field of the Invention

This invention relates to the Stock Exchange and casino slot machine gaming fields. More specifically, an electronic version of a slot machine is used to display stock portfolio performance.

2. Description of Related Art

There are many known physical slot machine devices that payout a sum of money based strictly on internal formulas contained within the slot machine device. A slot machine is a casino gambling machine with three or more, reels which spin when a button is pushed. Slot machines include a currency detector that validates the coin or money inserted to play. The machine pays, off based on patterns of symbols visible on the front of the machine when it stops.

In the recent past, virtual (or web-application based) slot machines have been developed for both gaming and entertainment purposes. While virtual slot machines operate in the same manner as the physical devices found in Casinos, when used for entertainment purposes, there is no true/real cash payout. On the other hand, some, virtual slot machines are associated with online gaming casinos, and may in fact payout funds.

Stock market investment banks have made available to their customers application-based utility tools online, as well via mobile computing devices such as smart phones and tablet PCs. These financial utility tools include stock market performance and can be customized to display a specific stock, or portfolio of stocks, current performance or over a defined period of time. With the emerging popularity of mobile computing devices, application developers have produced many types of stock utility devices, including ticker scrollers and stock widgets.

Stock Slots intends to merge the two concepts of a slot machine and stock performance utility tools as a way to provide stock or a specific portfolio of stocks current payout, and overtime. The Stock Slot application uses a unique formula to translate stock performance in a way that determines which wheel symbol will stop in the display window. The symbols that stop in the window are then translated into a specific cash payout. There are no such devices as described that are currently available.

### BRIEF SUMMARY OF THE PRESENT INVENTION

This invention uses stock market performance and translates that data into slot machine results. The application-based slot machine that uses a formula to translate stock performance into slot machine spin results.

$$S = {\sum }_{1}^{n} ( {C}_{n} - {P}_{n} ) * {x}_{n}$$

$${W}_{new} = {W}_{current} + S$$

S=spin result (winnings or loss)
W=wallet total
n=current company's stock
P=Previous quote for stock n
C=Current quote for stock n
x=number of shares of stock n owned

Stock Slots intends to combine the excitement and entertainment value of casino gambling with the importance of saving or investing. Where instead of “winnings” or “losses” being a result of gambling, they are a result of investment choices. By making investing/saving fun, Stock Slots intends to encourage smart investing rather than true casino gambling.

Users of the application do not insert funds in to the Stock Slots application. Instead, the users simply enter their previously purchased stock symbol and number of shares owned into the Stock Slots application, and then press the slot machines “spin” button. Once the “spin” button is pressed, the application uses a live feed of stock market performance data along with the Stock Slots formulas to determine which slot machine reel will display specific symbols, and how much money the user's stocks have gained, or lost, value. This data is displayed both in the form of total value of the portfolio, and by the incremental increase, or decrease, of value of the portfolio. In the spirit of casino gambling, this incremental value change is displayed by the Stock Slots application as “Winner Paid.”

### BRIEF DESCRIPTION OF THE SEVERAL VIEWS OF THE DRAWINGS

FIG. 1 is a device default view drawing;

FIG. 2 is a STOCKS Application Page Drawling;

FIG. 3 is a NEWS Application Page Drawling

FIG. 4 is a view showing exemplary slot machine symbols;

FIG. 5 is a view showing exemplary stock loss machine combinations;

FIG. 6 is a view showing exemplary stock gain machine combinations; and

FIG. 7 is a continuation of FIG. 6, showing exemplary stock gain machine combinations.

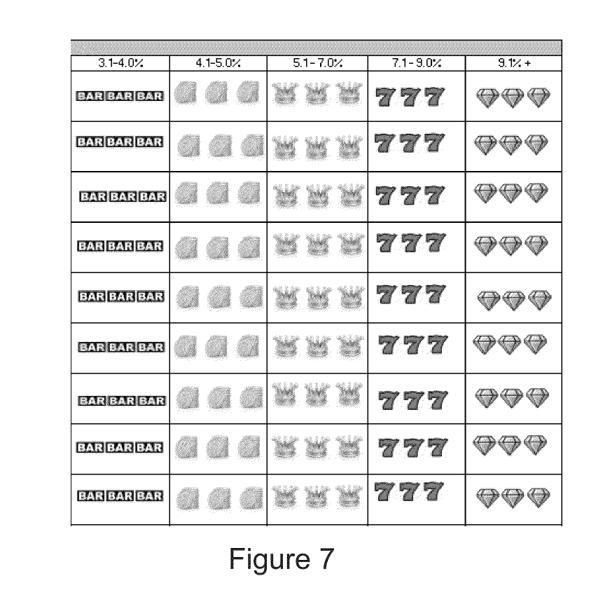

### DETAILED DESCRIPTION OF THE INVENTION

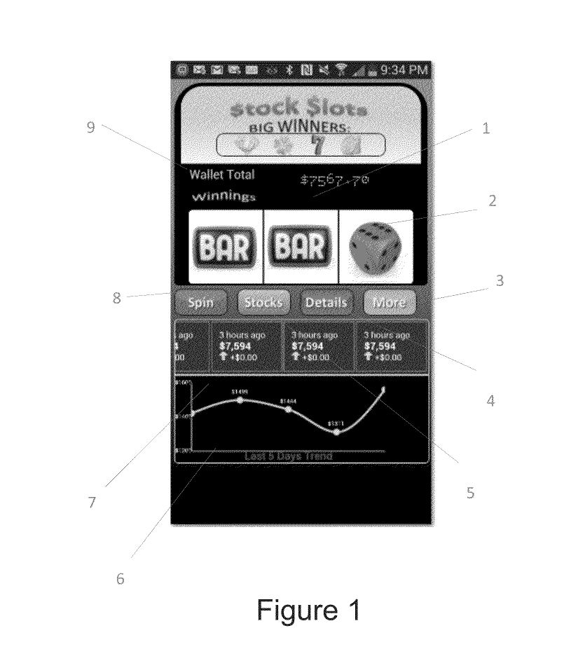

Referring to FIG. 1, (1) a payout is based on % of stock value change since last spin; (2) After spin stops, the total payout figure progressive builds with bell sounds chiming (not an instantaneous result) and the wheels stop sequentially. Logic is based ‘spin formula” (see below); the button (3) takes the player to the Settings and Themes application page; the button (4) takes the player to the Details application page; and the button (5) takes the player to the Stock Portfolio application page; an area (6) aggregates the total stock portfolio performance and displays as a single trend line graph; an area (7) captures the history of each spin and displays a single ‘tile.’ Extended historical tiles can be viewed by sliding a finger horizontally across the spin tiles. Data of each spin captured includes wallet (total portfolio) value at the time of the spin and trend of value since previous spin; a button (8) starts machine/wheel spin; and the application (9) calculates the total portfolio value and inserts this within the “Wallet Total” field.

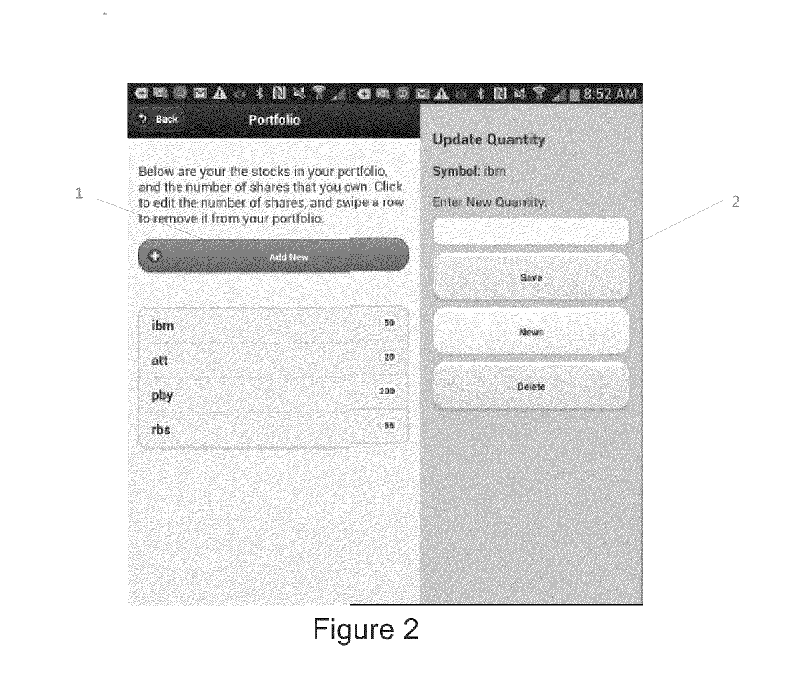

Referring to FIG. 2, a STOCKS Application Page allows a player to add valid stock symbol by selecting the “Stocks” button (this button is found as #5 in FIG. 1). The player can add a stock symbol by selecting the “Add New” button. The player can enter the number of shares that have been previously purchased. Application system calculates the value of the stock based on the number of shares times the current value of each share. The application pulls in data automatically from Yahoo Finance.

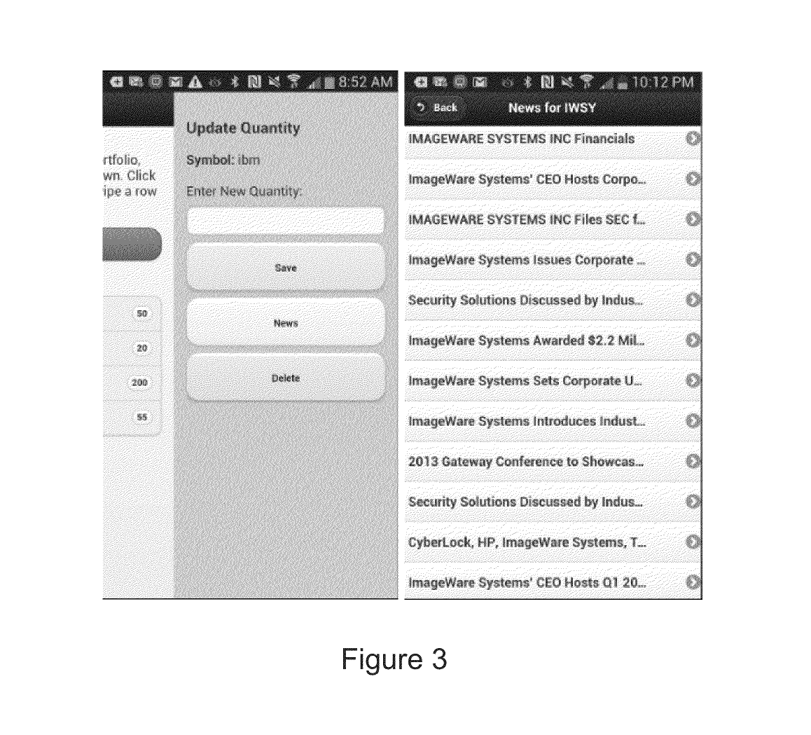

Referring to FIG. 3, on a NEWS Application Page allows a player to access the latest news feed from Yahoo Finance by selecting a stock in the portfolio as displayed within the Stocks application page, followed by selecting the “News” button. More detailed news can be obtained by selecting each news headline. The application takes the player to the detailed news article as found on Yahoo Finance.

This invention uses stock market performance and translates that data into slot machine results. In the case of the first time user, he or she builds a portfolio by entering the symbol(s) for the shares of stock(s) that he/she owns, and entering the number of shares of each owned. This determines the initial Wallet.

For example, assume the user entered an initial portfolio of stocks in two companies, IBM (IBM) and Apple Computer (AAPL). Also assume they entered quantities of 10 shares of IBM and 1 share of Apple at current market prices of $50 and $800 respectively. The initial wallet amount would be $1300.00 (10×50+1×800).

The user then spins the wheels, and the application queries for current market prices of both stocks in the portfolio. Assume for this example that the price of IBM increase to $51 per share, and the price of Apple stock stayed the same at $800 per share.

The spin formula above yields S of $10. [51-50]*10=10+[500-500]=0.

The spin gain percentage is then determined by dividing the result of the spin (S=$10) by the original portfolio and multiplying by 100. In this example, it is 10/1300*100, or 0.76%. Note that the spin gain percentage may be positive or negative.

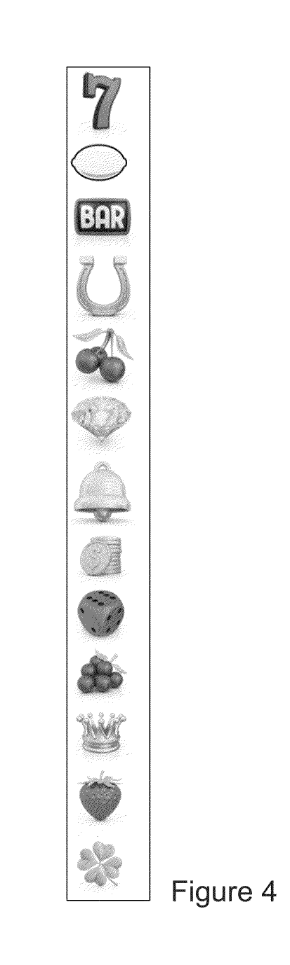

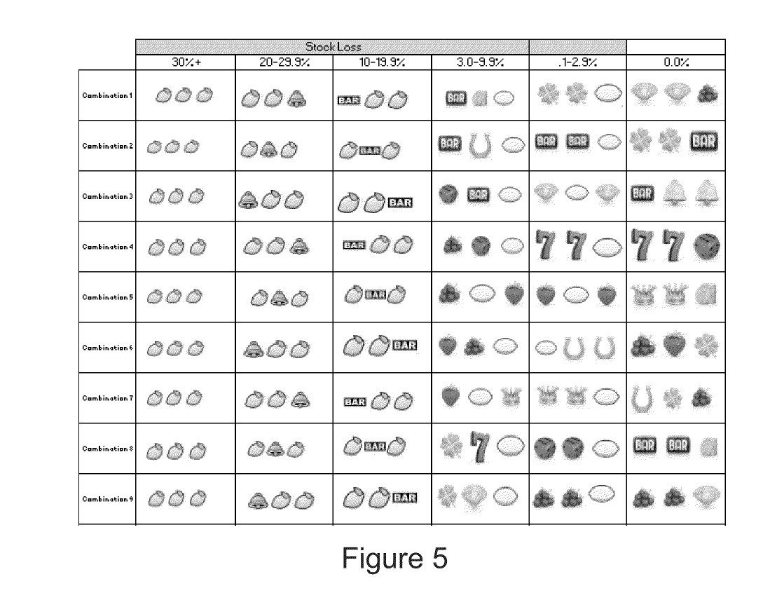

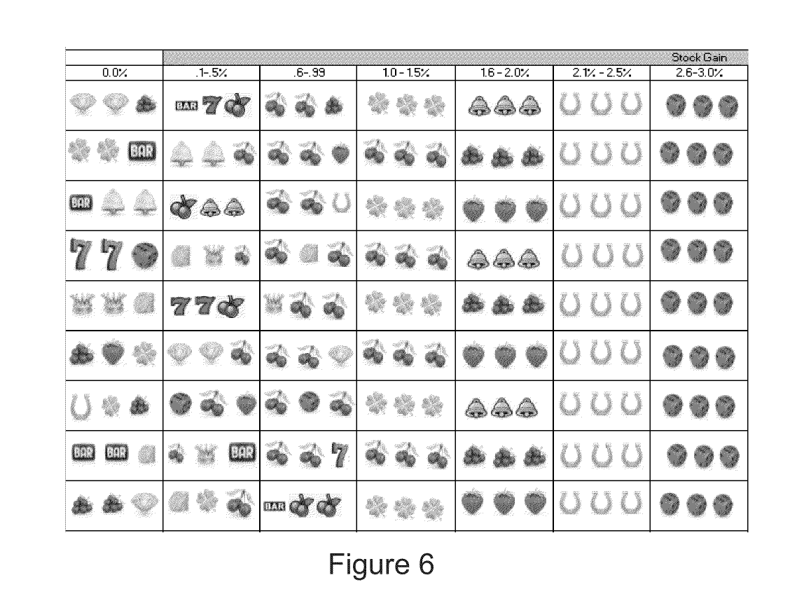

Reels (see Device Default View Drawling, FIG. 1) are built using a strip sized 100 wide by 1300 high (pixels) see FIG. 1 below “Classic Slots” strip. The stop positions of the reels are then determined by comparing the spin gain percentage to the Reel Log Charts (see FIGS. 4, 5 and 6 below). For a stock price gain of 0.76% there are six possible matches. The invention generates a random number between 1 and 9 (or the number of combinations) to determine which of these symbol combinations would be used.

Let us assume in this example that the random number generated is 1, so the combination is Bell, Bell, Bell.

When the spin button is pressed, the reels begin the animation of spinning. Each reel is a 100 wide by 1300 high, graphic, with the symbols being evenly spaced vertically at 100 pixel increments. The wheels are started at different times so as to guarantee that they are not all showing the same symbols at the same time as they spin. The symbol combination (Bell, Bell, Bell in this example) is translated into a stop position for each wheel. In the 100×1300 graphic, the bell is at position 6, so in this case, for each wheel, the stop positions are defined as 600, 600, 600 for each reel.

The invention gives each reel a minimum spin time (0.5 seconds for the first reel, 1 second for the second reel, and 1.5 seconds for the third reel) to guarantee that they stop in sequential order.

After each minimum spin time has passed, the corresponding wheel animation is slowed. This allows for more accurate sampling of its current position. Each reel's vertical position is sampled as fast as the processor and OS of the device allow. When the current vertical position of the current reel is equal to its stop position, the wheel is stopped. The next wheel (left to right) is then slowed and sampled until all wheels are stopped on the correct symbol.

In summary, the invention translates an entered stock market portfolio of shares into a slot machines wheel logic. This logic also translates resulting combinations of symbols into “Winnings” and therefore “Wallet” (see Default Device View Drawling).

1. A method for tracking the performance of investments on a mobile electronic device, comprising:
inputting one or more investments into the mobile electronic device;
electronically tracking at least one of the one or more investments; and
displaying, on the mobile electronic device, results of the tracking of the at least one or more investments as a slot machine display of three or more slot machine symbols.

2. The method of claim 1, wherein the at least one of the one of more investments includes an entire portfolio of stock investments.

3. The method of claim 1, wherein the one or more investments are selected from a portfolio of a portfolio of investments.
